(19) United States
(12) Patent Application Publication
(10) Pub. No.: US 2014/0032430 A1
(43) Pub. Date: Jan. 30, 2014

(54) TITLE TRANSFER APPLICATION AND METHOD

(71) Applicant: Joseph Michael Sieger, Barrington, IL (US)

(72) Inventor: Joseph Michael Sieger, Barrington, IL (US)

(73) Assignee: INSURANCE AUTO AUCTIONS, INC., Westchester, IL (US)

(21) Appl. No.: 13/901,246

(22) Filed: May 23, 2013

Related U.S. Application Data
(60) Provisional application No. 61/651,865, filed on May 25, 2012.

(51) Int. Cl. G06Q 50/18; G06Q 10/06

(52) U.S. Cl. CPC G06Q 50/18; G06Q 10/06
USPC 705/311

(57) ABSTRACT

A method and apparatus includes an app on a smartphone that assists a policy holder in transferring title of a damaged vehicle to an insurance company or other party by requesting that the user compare the title at hand to images of versions of vehicle titles, by requesting information on the names and number of owners on the title and whether any lienholders are named on the title. Instructions are sent to the user as to executing the title for transfer. The smartphone is used to photograph the executed title and the photos are uploaded for review. After review, the title with any changes requested by the reviewer is forwarded to the insurance company.

### CROSS-REFERENCE TO RELATED APPLICATION

This application claims the benefit of U.S. Provisional Patent Application Ser. No. 61/651,865, filed May 25, 2012, which is incorporated herein by reference.

### BACKGROUND OF THE INVENTION

1. Field of the Invention

The present invention relates generally to a method and apparatus for communicating information relating to vehicle titles, and more particularly to a software application operating on a mobile electronic device embodying a method and apparatus for communicating information relating to vehicle titles.

2. Description of the Related Art

Vehicle owners occasionally wish to sell their vehicles or otherwise transfer the ownership title to another party. Ownership of the vehicle is denoted by a title document. Each state issues its own vehicle title documents and for many states there are multiple different title forms in use or that have been used over the years. It can be confusing for vehicle owners to properly transfer the title to their vehicles and mistakes in executing the forms are not infrequent.

Vehicle owners, who have their vehicles insured with an insurance company or insurance carrier, as is required in many states, may have the insurance company take ownership of the vehicle as part of the insurance settlement if the damage to the vehicle is sufficiently great, such as may occur as a result of an accident or natural disaster. It is common that the insurance companies or insurance carriers transfer the damaged vehicles to a vehicle auction company who auction off the vehicles. To transfer the ownership of the vehicle to insurance company or the vehicle auction company, the owner of a damaged vehicle is asked to make the title negotiable, such as by signing and dating the title document at the correct location on the document and with the correct name or names. The signed, or executed, title is then sent to the insurance company or vehicle auction company.

The insurance companies or auction companies receive many such titles from vehicle owners but in a number of cases the efforts by the vehicle owner to affect a transfer of the title are incorrect or insufficient to make the title document negotiable. For instance, the owner may sign the title at the wrong location, such as on the front rather than on the back of the document, or only one owner signs the title in cases where the signature of both owners is required to affect the title transfer. Some title forms have multiple locations that could be interpreted as signature lines, but only one signature location is to be used for a negotiable title. Correcting these errors in the title execution of a title takes time and expense.

### SUMMARY OF THE INVENTION

The present invention provides, in one embodiment, a method and apparatus by which a vehicle owner may match the vehicle title for their vehicle to the one of the several types of titles in use. The user is provided with information to determine the title type and the particular characteristics of the title, such as the number of owner signatures required to affect a transfer and the location on the title where the owner or owners are to sign. The user receives instructions for affecting a transfer of the title at hand. The instructions may include information as to where on the title document the owner or owners are to sign, how many signatures are required, and any other information required to make the vehicle title at hand negotiable.

In another embodiment, the present invention provides a method and apparatus by which a user may have a vehicle title reviewed to determine if the user's efforts to make the title negotiable are correct. An image file of the title that the user has attempted to make negotiable is transmitted for review. After examination of the images by a reviewer, the user receives a response indicating whether the attempt was successful and providing further instructions relating to the title transfer. The instructions may include instructions for correcting an error in the execution attempt. If the execution effort was correct, the user is so informed. The user can thereby have the executed title document reviewed prior to forwarding the document to the receiving entity.

A further embodiment provides a method and apparatus for providing instructions to the user for forwarding the title to the receiving entity as a negotiable title. The instructions may include instructions to include with the executed title a death certificate for a deceased owner or a power of attorney form for correcting an error in the documents or to issue a new title, and/or may include instructions on use of a trackable transfer service for sending the title.

### BRIEF DESCRIPTION OF THE DRAWINGS

FIG. 1 is schematic diagram of a system for performing the method according to the principles of the present invention;

FIG. 2 is a block diagram illustrating entities involved in a method according to an embodiment of the present invention and showing steps associated with the method;

FIG. 3 is a screen shot of a display showing thumbnail images of versions of title documents of a state in portrait orientation;

FIG. 4 is a screen shot of a display showing thumbnail images of versions of title documents of a state in landscape orientation;

FIGS. 5-7 are screen shots of a vehicle display application;

FIGS. 8-10 are informational images of an embodiment of the vehicle display application;

FIGS. 11-22 of Flow 1 are sketches of screens of a portable mobile device showing a first embodiment of the method and apparatus;

FIGS. 23-38 of Flow 2 are sketches of screens of a portable mobile device showing a second embodiment of the method and apparatus; and

FIGS. 39-46 of Flow 3 are sketches of screens of a portable mobile device showing a third embodiment of the method and apparatus.

### DETAILED DESCRIPTION OF THE PREFERRED EMBODIMENTS

An embodiment of the invention provides a method for a user, such as a policy holder of an insurance policy or an owner of a vehicle or other person, to compare an owner title to known vehicle title formats and versions and thereby determine which format and version of title has been used for the vehicle title. The user is provided with instructions for affecting a transfer of the title to a new owner, such as an insurance carrier or a vehicle auction service. In a preferred embodiment, the method is carried out using an iPhone, Android phone or other smartphone device.

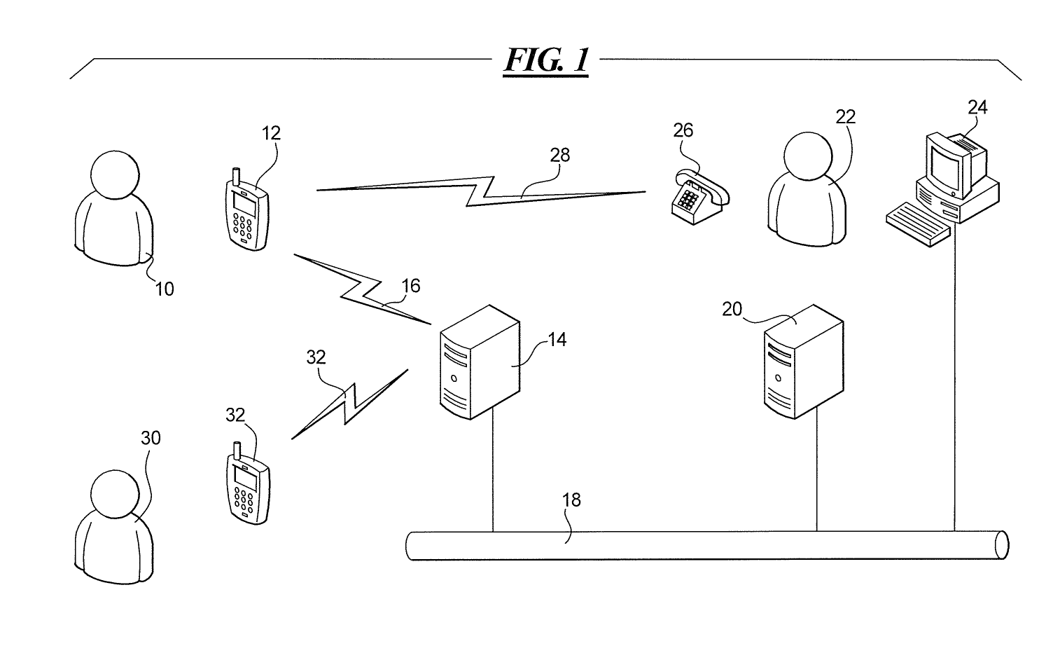

In FIG. 1, a user 10 is an owner of a vehicle or is acting on behalf of the vehicle owner, such as an administrator of the estate of the owner, or may be a friend, relative, assistant, caregiver, or some other person performing the user steps of the method. The owner or user 10 desires to transfer the ownership of a vehicle to another party. The vehicle may be an automobile, truck, van, motorcycle, motor scooter, boat, trailer or other titled property. In the example, the vehicle has been damaged, such as in an accident, flood, storm or other event, and the insurance company that insured the vehicle has offered to take ownership of the vehicle as part of the insurance settlement. The user 10 is requested to locate the title to the vehicle and perform the following steps to affect a transfer of ownership of the vehicle.

The user 10 is requested to download and install an application or program on an iPhone, Android operated phone, or other smartphone device 12. The application or program may instead be provided on a computer device such as a tablet computer, personal digital assistant, netbook computer, laptop computer, notebook computer, desktop computer, kiosk, workstation, or other mobile or stationary electronic device. The display is described herein as a touch-screen display but other types of displays and user interfaces are also within the scope of the present invention. The application program, also referred to as an app, is downloaded from a server 14 via a communication link 16. The server 14 may be any type of computer or server device and is preferably connected to a network 18. A plurality of servers 14 may be provided in a single location or in distributed locations. The communication link 16 may be a wireless communication link such as via cell phone network, Wi-Fi, Bluetooth, radio frequency, or other wireless communication means, or may be a wired communication link such as Ethernet, LAN, WAN, telephone wiring, cable or other wired communication, or may be a combination of both wired and wireless communications. A portion of the communication link 16 may be via the internet or other network.

As will become apparent, the server 14 or plural servers may have stored thereon or accessible thereto a database of title images in a library of title forms, a database of queries to ask the users, and a database of instruction sets to send to the users.

Once installed on the smartphone 12, the app appears as an icon which can be selected for execution by the user 10. By selecting the app icon, the application is executed by the processor in the smartphone or other device 12 and begins displaying a sequence of screens and performing a series of operations with user input. The application displays on the display screen of the smartphone 12 a series of inquiries to the user 10 to enable the application to determine the type of vehicle title that the user has. The selected displays are retrieved over the communications link 16, possibly over the network. Different portions of the transmitted information may originate from different servers in the system.

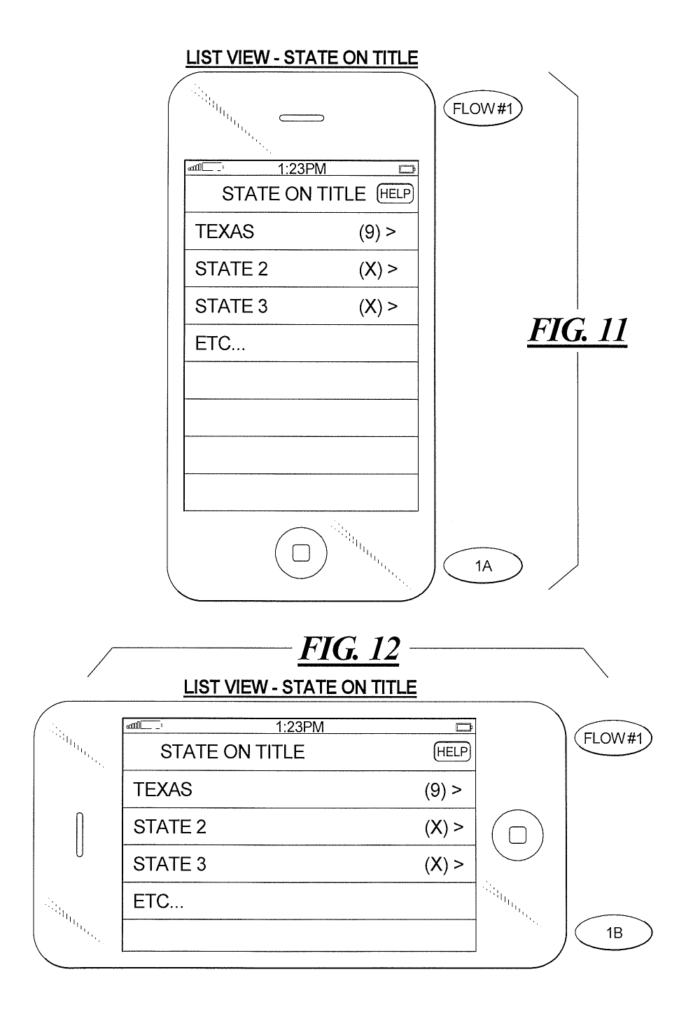

Turning to FIG. 11, initially, the application program may display a title screen and/or informational screen for the user as the application is starting. Instructions or other information may be provided. One such instruction is that the user should have the vehicle title for review while executing the application. It is preferred that the user have the title in hand or on a table or the like as the inquiries are being presented. In the title identification portion of the application, also termed Flow #1 in the example, FIG. 11 of Flow #1 lists states that may be identified on the title as the issuing state. In the display 100 is provided the header 102 “state on the title” below which is a listing of states 104. The first listed state is Texas 104a, next to which is a number 9, at 106, to indicate the number of types of titles recognized by the application for vehicles titled in Texas. Below Texas 104a are listed other states 104b, 104c, each with an indication of the number of title types recognized for the respective state. An arrow or other indication 108 next to each state indicates that the user 10 will obtain more information by selecting a state from the list. Should the user need any assistance at this step or other steps, a help button 110 is provided. The display 100 is provided on a device having a touch screen so that the user may select a displayed item by touching the displayed item on the screen. Alternatively, the user may select an item using a mouse, touch pad, joystick, keypad, or other pointing or selecting device.

Also on the display is a battery indicator 112 showing the status of the power supply, such as remaining charge on the battery or if the smartphone is charging. A signal strength meter 114 and signal provider indicator 116 are provided to indicate the status of wireless communications. A time display 118 is also provided on the device. These elements may remain on screen on the display 100 of an iPhone for each screen of the application in the illustrated example. Other devices or other versions of devices may include different display elements.

In the present example, the user has a vehicle for which the state of Texas has issued the title, so the user selects Texas from the list.

FIG. 12 of the Flow 1 shows the state listing display 100a when the smartphone is rotated to switch the display to a landscape view. The application still asks for the state on the title 102 and still includes a listing of states 104 along with an indication of the number of different title types 106 recognized by the application for each state. In this example, the State of Texas has used nine different versions of vehicle titles over the years. In both the portrait orientation 100 and the landscape orientation 100a of the state listing, the display of the smartphone may be too small to show a complete listing of the states. As such, the display is scrollable, such as by using a finger swipe motion on the touch screen, using up and/or down arrows, page buttons, or otherwise providing for the display of additional information on the screen.

In FIG. 13 of Flow 1, the user has selected Texas 104a as the state that issued the title of the vehicle. A listing 120 of possible title types issued by the State of Texas is presented including a thumbnail, or reduced size, image 122 of each title type, a heading 124 and a description 126 of each. The thumbnail view 122 is preferably in color and may show that some titles were issued with blue printing while others were issued with green printing, for example. The layout and appearance of the title is shown by the thumbnail images 122. The thumbnail images 122 are drawn from a library of title images that have been collected from current and older versions of title documents. The title document images may have the identifying information obliterated or redacted and serve as samples of title version or style.

The headings 124 and descriptions 126 in the listing may also be helpful to the user to determine which version of title the user has at hand. The titles 120 are preferably listed in date order, typically with the more recent version of title shown at the top of the display 128 and increasingly older titles shown below. The user 10 selects the title 120 that looks the most like the title the user has on hand, such as by taping the corresponding portion of the display 128. The display 128 is scrollable to permit the user 10 to scroll to the corresponding title, although as noted paging through the display may also be provided. A back button 130 is provided to take the user back to the states listing 100 and a help button 110 is also provided.

FIG. 14 of Flow 1 presents the landscape version 132 of the display. By comparison to the portrait orientation of FIG. 13 where only the front of the title 122 is shown in a thumbnail view, the landscape orientation 132 of FIG. 14 also displays a thumbnail view of the back 134 of the title document. This may be helpful where a difference between different title versions is apparent on the back of the documents rather than appearing on the front of the title document. In the landscape view 132, room for only two title examples are shown on the display, whereas the portrait display 128 of FIG. 13 provides room to show three title documents. Only the front image 122 is shown in the portrait orientation, although it is foreseen that the application may display the back of the document, such as by tapping the thumbnail image.

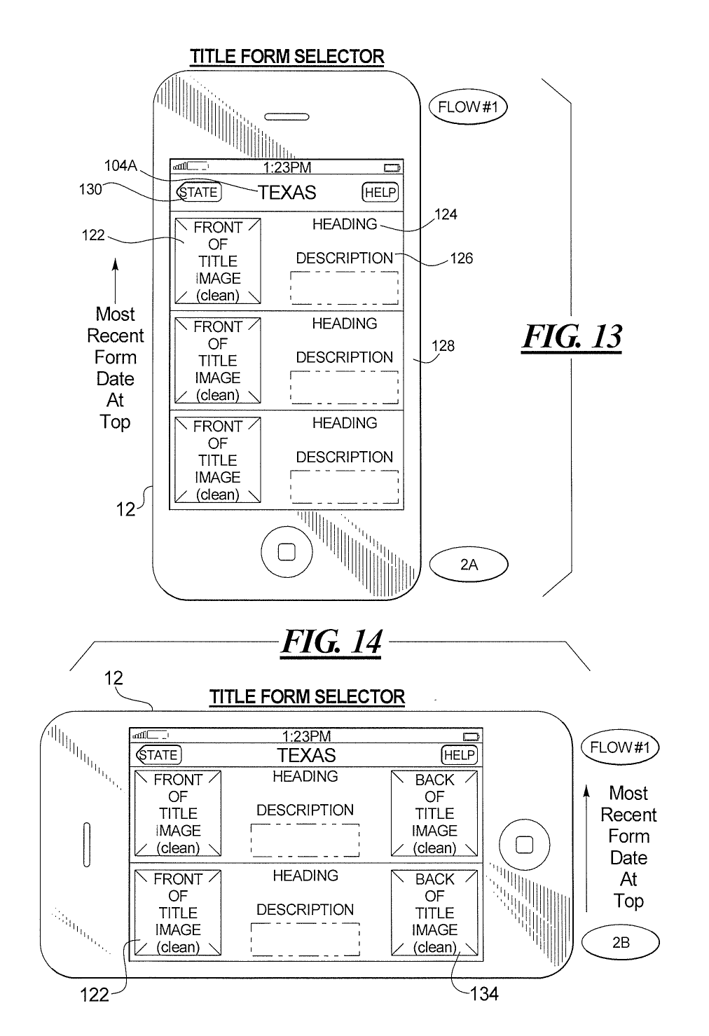

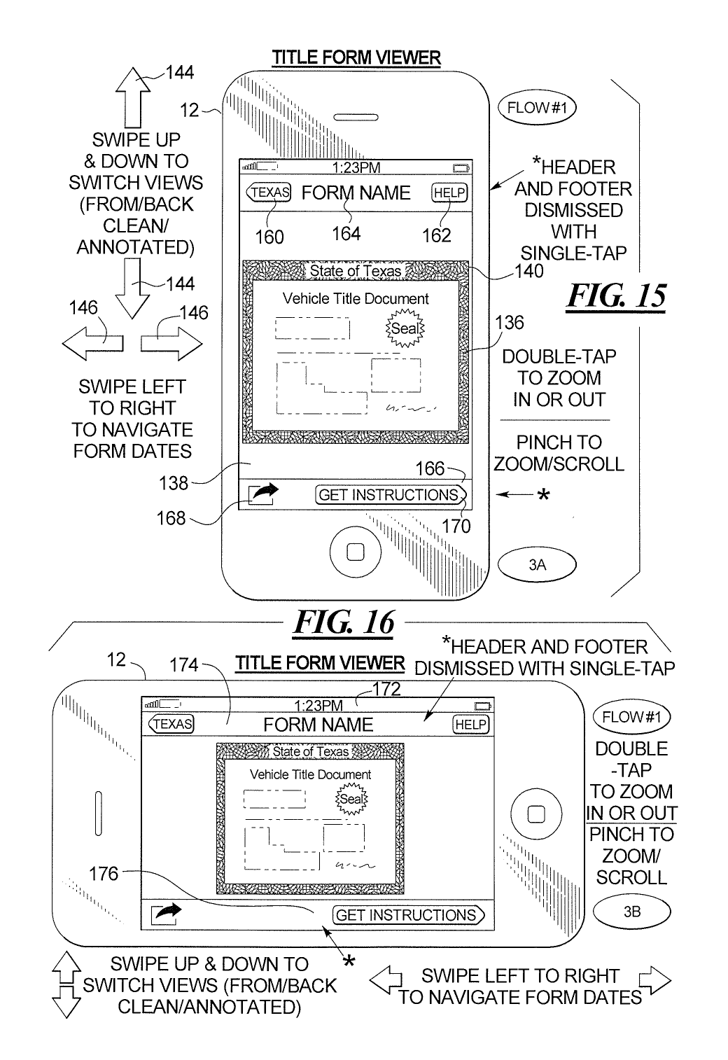

FIG. 15 of Flow 1 shows an enlarged image 136 of the selected vehicle title version from the selected state in portrait display mode 138. The title is shown in two versions, a clean version 140 which appears as the title would appear and an annotated version 142 which points out features of the illustrated version, such as pointing out differences between the different versions. The title is also show as an image of the front of the document and as an image of the back of the document, each of which may be provided in clean and annotated versions. The user may switch between the clean 140 and annotated 142 views and the front and back view by swiping a finger over the touch sensitive display 138. For example, a vertical swipe of the finger as indicated by arrows 144 may change between the different displayed images.

Another feature provided in a preferred embodiment of the method and apparatus is referred to as two-dimensional swiping. The user can swipe a finger across the touch sensitive screen in both vertical and horizontal directions. The horizontal, or left-right swipe, as indicated by arrows 146 is used to change the view to a different object. The vertical, or up-down, swipe 144 is used to change the view to another image of the same object. For example, in the title transfer app the left-right swipe 146 is used to change to a different title form and the up-down swipe 144 is used to change to different views of the form—including front un-annotated view of the title form, rear un-annotated view, front annotated view and rear annotated view. The swipe view changes are connected in an endless loop so that swiping past a last image results in the first image being displayed, etc. Endless looping of the title form versions and the views of each title form is provided or the swiping can result in the user reaching the end of the available forms and swiping the other direction. This is referred to as two dimensional swiping.

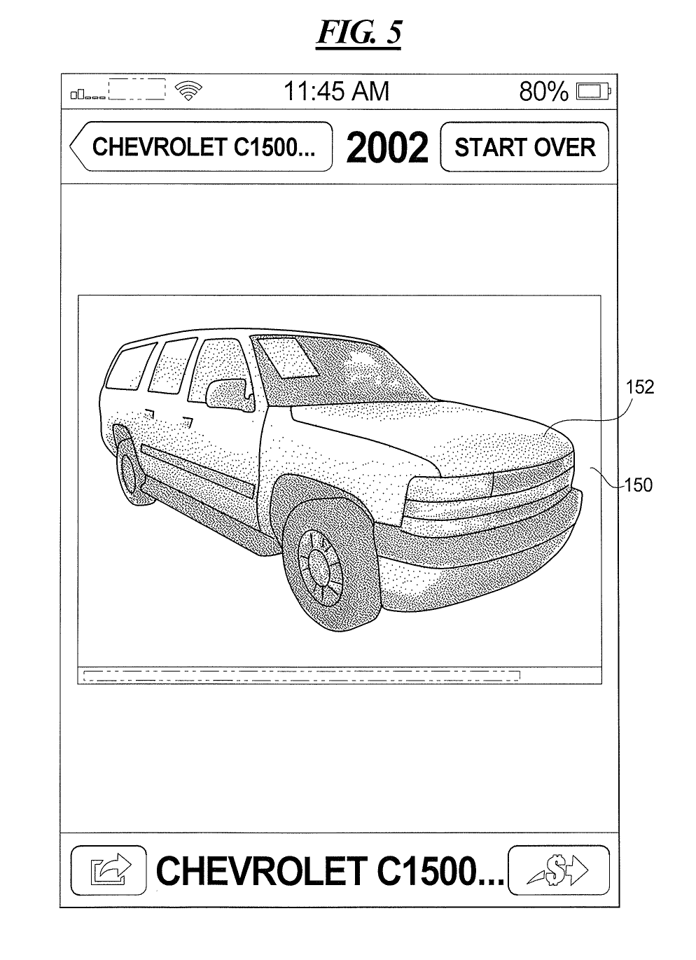

The two dimensional swiping method can be applied to other applications as well. For example, a vehicle auction service that wishes to present vehicles available for auction may provide a photographic gallery of the vehicles. The user can access an image of a vehicle by selecting the vehicle and is thereby shown a photograph of the selected vehicle. FIG. 5 is an example of the application 150 displaying a selected vehicle 152. By right-left swiping, the user is shown photos of other vehicles. FIG. 6 shows a screen shot 154 mid-swipe as the user is about to view the next vehicle 156 in the series. A series of images of vehicles can be viewed by swiping the touch sensitive screen to access each successive vehicle. Although the user can reach the end of the series and scroll back through the other direction, looped scrolling may be provided instead.

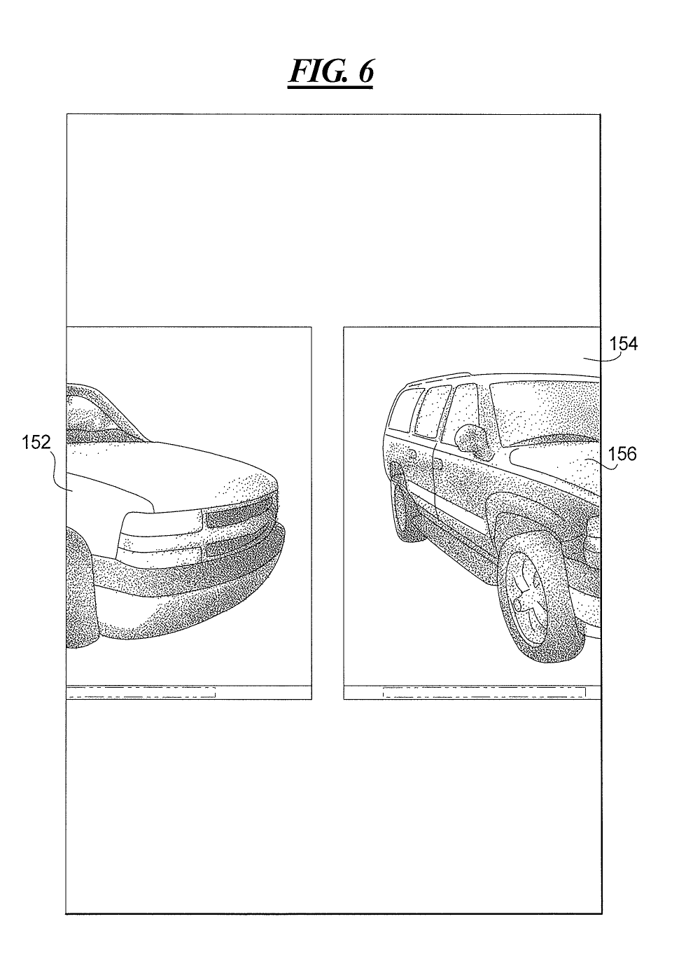

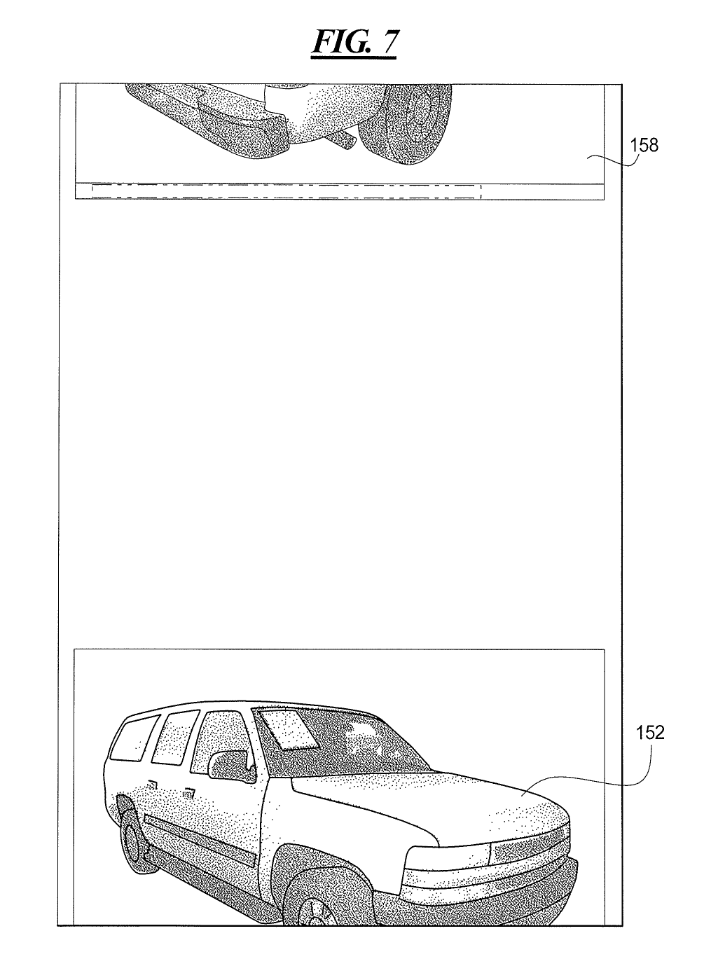

In FIG. 7, the user desires to see more photographs 158 of a vehicle 152, and is able to swipe vertically to move to other photos 158 of one vehicle. The user can thereby see photos of the front, back, sides and inside of the vehicle 152 by performing a vertical swipe. It is of course possible that the vertical swipe motion can be used to move from vehicle to vehicle while the different views are accessed by side-to-side swipes.

The two dimensional swiping can be applied to many different objects and fields, without limit. For instance, real estate may be presented at an on-line site that uses swiping one direction to view other photos of one property, while swiping in another direction shows photos of other properties. On line product catalogs, photographic albums of family events, and many other photographic display applications can benefit from the two dimensional swiping of the present invention.

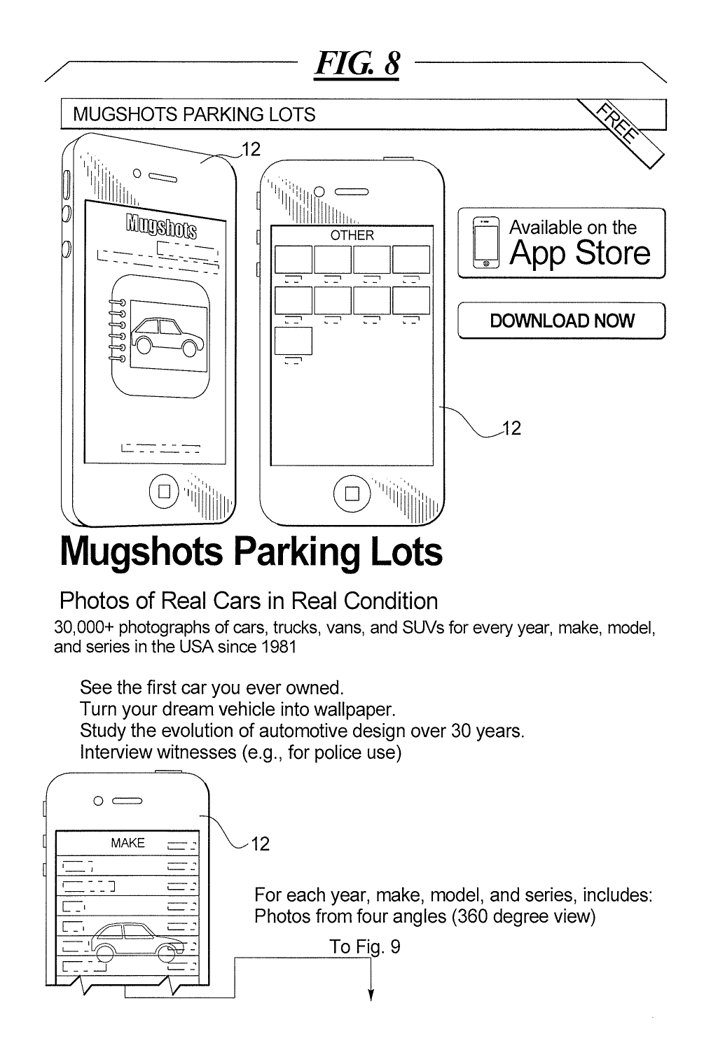

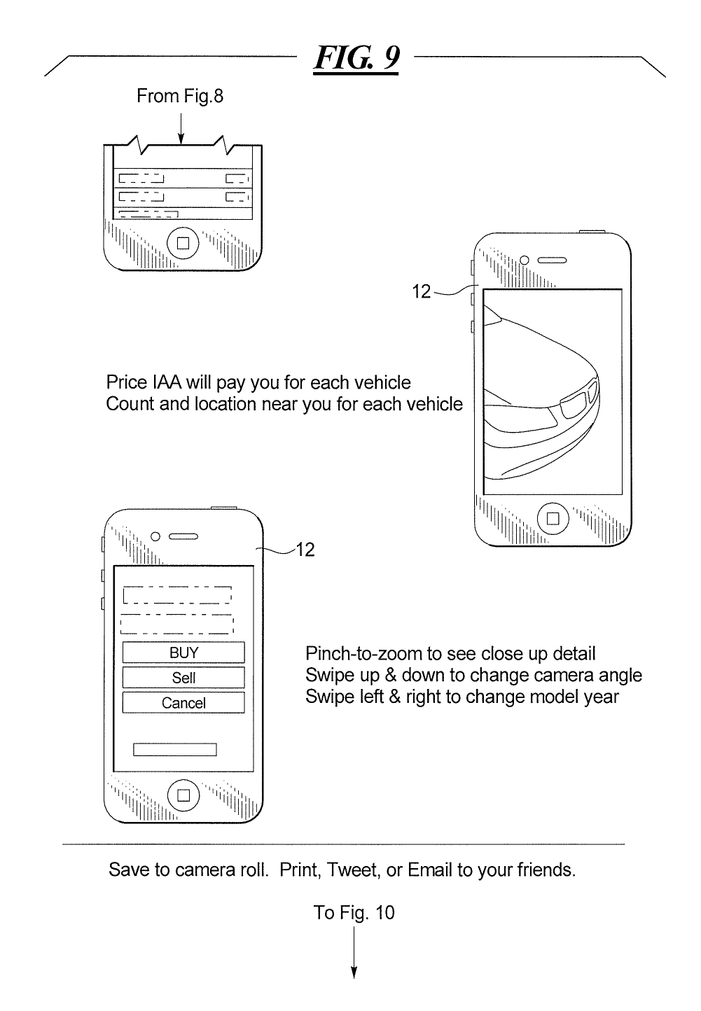

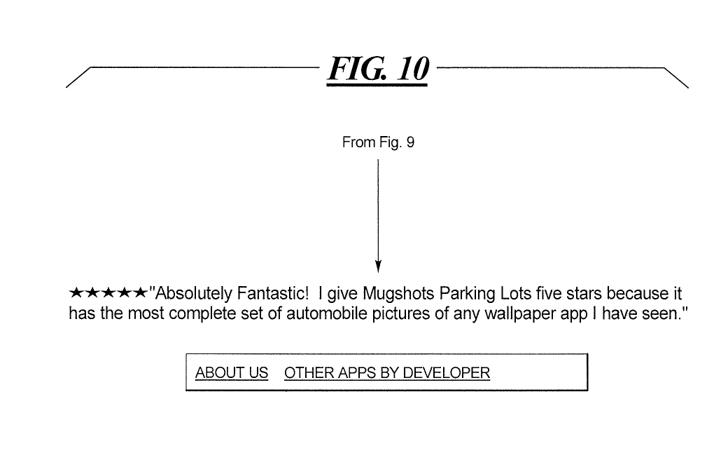

FIGS. 8-10 are web pages showing features of an application for two dimensional swiping to view vehicle photos according to FIGS. 5-7.

The title view of FIG. 15 can be changed to display the other versions of the state titles, such as by the user swiping a finger over the touch sensitive screen from side to side as indicated by the arrows 146. So, for example, should the user by examining the displayed sample title 140 and comparing it to the vehicle title on hand determine that the displayed sample 140 does not match the title on hand, the user may switch the display to another version of a title issued by the state. Alternately, the user may exit the title view by selecting the back button 160, shown here as the Texas button, so as to return to the thumbnail listing. The user may then re-enter the title view for a different title version by selecting a different title thumbnail image.

The displayed image 140 of the title may be enlarged for viewing details for example by double tapping on the touch sensitive screen or by performing a two-finger pinch/stretch motion on the screen, as is known. Then enlarged, the enlarged view can be moved about the screen by swipe scrolling motions using the finger on the screen. The header portion of the display includes a back button 160 to return to the state screen, a help button 162, and a header 164 that names the form being displayed, such as identifying the dates when that version of the title form was being issued by the state. The header portion may be hidden by tapping the corresponding portion of the screen.

A footer portion 166 of the title screen is also provided, which has a back button 168 to return to the form listing. A get instructions button 170 is provided for selection by the user when the user has determined that the title shown on the display is the same version as the title on hand.

FIG. 16 of Flow 1 shows a title screen 172 in landscape mode. The same scrolling and zooming capabilities exist. The ability to hide the header 174 and footer 176 by tapping may be more useful in the landscape orientation.

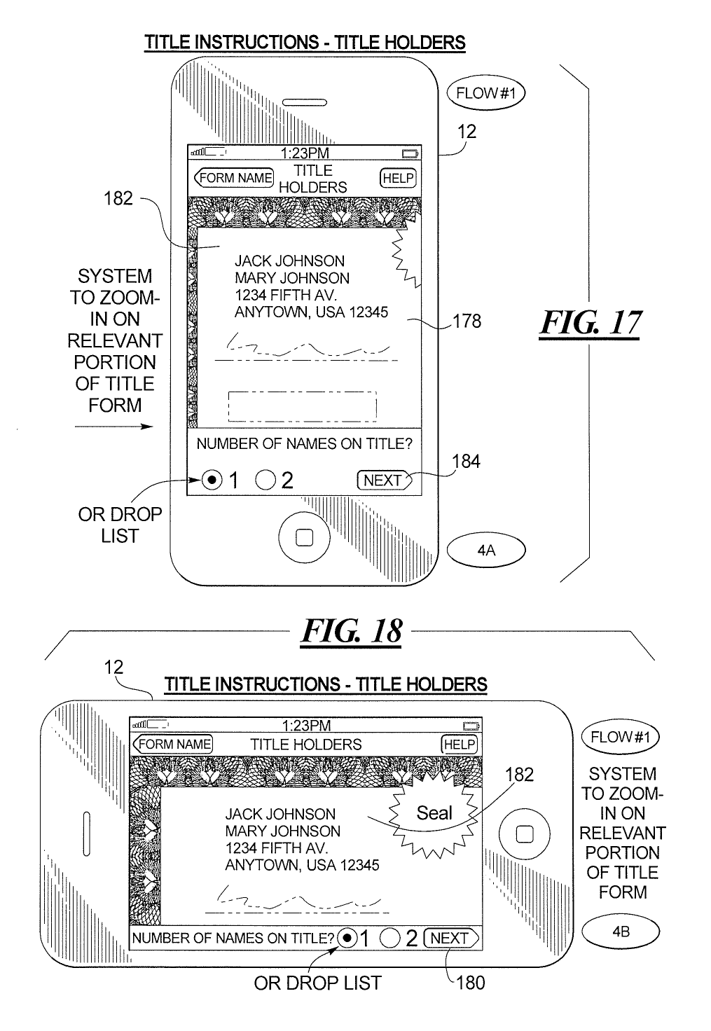

Once the user has determined the title version and selected the command to “get instructions,” the instructions 178, as shown in FIG. 17, are delivered to the smartphone from the server. The instructions 178 include visual cues as to features that the user should look for on the title on hand. For example, the instructions may show a title having two owners named on the title document and may ask the user to identify how many owners are named on the title document on hand. The question is answered here by so-called radio buttons 180, although drop down lists or other means for answering the question are contemplated. This information will become important because a title that names two owners will require a signature from both owners to affect a title transfer. The inquiry by the application program may occur by automatically zooming in the display on portions 182 of the title having the information in question. After the user answers the question about how many users appear on the title on hand, the user selects the next button 184.

FIG. 18 provides the number of owner inquiry function in the landscape mode of the smartphone or other electronic device. The proportions of the enlarged part 182 of the title are different in this display mode, so here the seal 186 on the title is visible whereas it was not in the portrait mode display of FIG. 17.

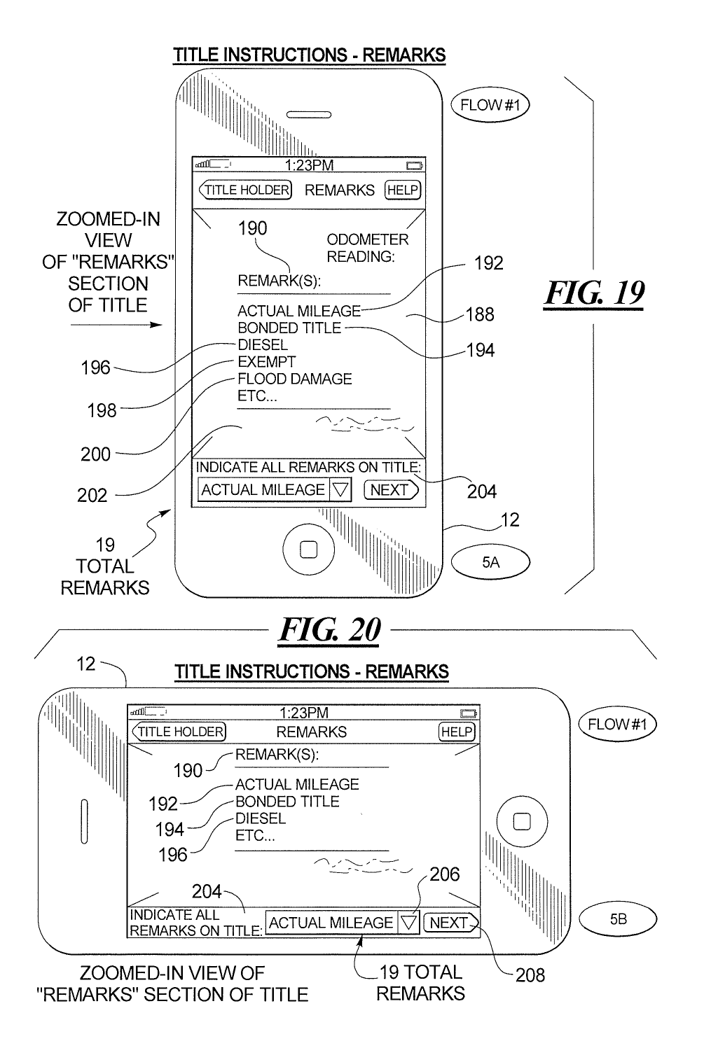

Additional information on the title may be important in the user's comparison and in determining an appropriate set of instructions. In FIG. 19 of Flow 1, the display 188 zooms in to remarks portions 190 of the displayed title. The location of the VIN (vehicle identification number) of the vehicle may be shown and the user may be requested by the app to enter the VIN number in the app. The displayed remarks may indicate the actual mileage 192 of the vehicle when the title is transferred, whether it is a bonded title 194, the engine type 196 of the vehicle such as whether it is diesel or not, whether the vehicle is exempt 198, whether the vehicle has been subject to flood damage 200, or other issues. An entry space 202 is also provided for the odometer reading of the vehicle. It may be necessary for the user to fill in such information on the title as part of the transfer process or to otherwise note the presence or absence of each information item in the remarks. At the lower portion 204 of the screen is an inquiry to the user to indicate all the remarks that appear on the title on hand.

In the illustration of FIG. 19, there is displayed a selectable item 206 for actual mileage, which includes a pull-down menu that opens a number pad for entering the mileage of the vehicle being transferred. In one embodiment, there are 19 possible remarks that may appear on the title. The present application checks for each of these. As with other display screens showing the title document, the view may be zoomed in and out by tapping or “pinching” the touch screen or scrolled by swiping. After the user has completed review of this screen, the user may select the “next” button 208.

FIG. 20 of Flow 1 shows the landscape orientation of the remarks portion 190. The same information is presented, but may require scrolling by the user to see all of the remarks.

FIG. 21 of Flow 1 inquires as to the lienholders 210 of the vehicle. The title is enlarged to show the lienholder listing 212, here showing first, second and third lienholders. The user is asked to indicate the number of lienholders on the title on hand. The user may answer this inquiry by a drop-down menu 214 or by radio buttons or other data entry means. After entering the number of lienholders, the user selects the “next” button 216.

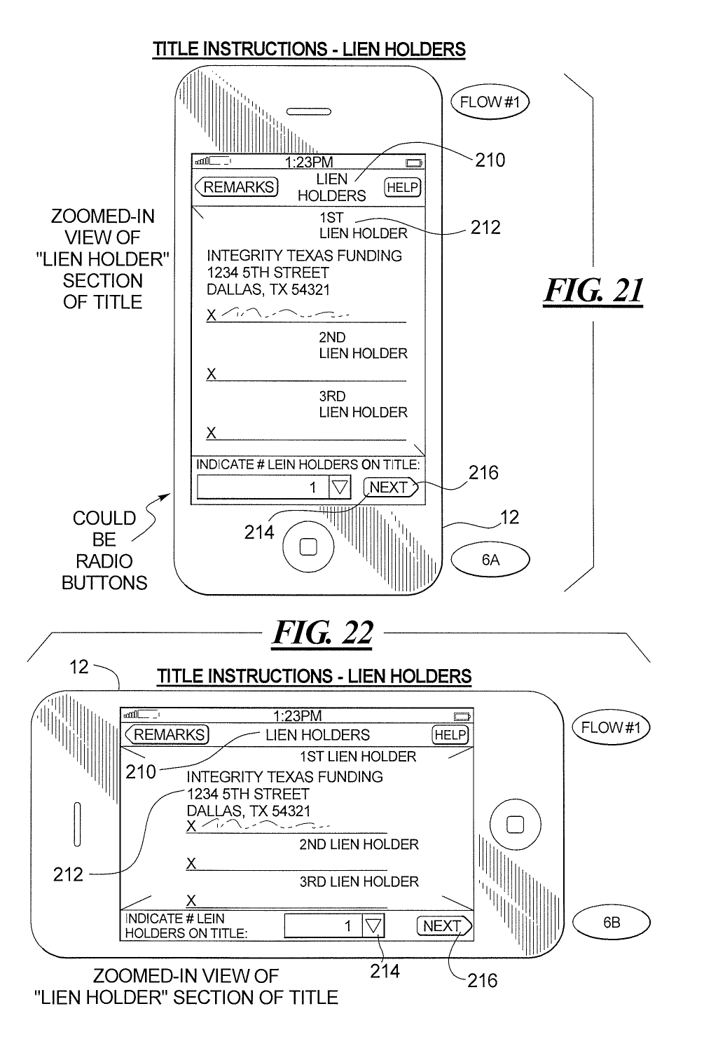

FIG. 22 of Flow 1 shows the landscape orientation of the lienholder screen 210. This completes the inquiry screens of the example. Of course, fewer or more screens may be provided, depending on the type of title that the user has on hand, the state that issued the title, answers to the information provided by the user, etc.

Having completed the Flow 1 part of the user interaction, the application on the smartphone acquires from a server via the wireless connection (as seen in FIG. 1) a set of instructions to the user directed to the specific type of title that the user has on hand. The instructions are customized for the particular title. For example, if the title requires a signature of two owners on the back and an entry of the odometer reading on the front of the title document, the instructions include this information. If the title requires something from the lienholder, the instructions provide this information. If the title is in the name of a deceased person, the instructions may ask that a copy of the death certificate be included. Other issues may be addressed by having the owner or user execute a power of attorney for purposes of correcting errors or addressing title issues or issuing a new title. All, or at least nearly all, special requirements for transfer of the title on hand are included in the instructions sent to the user. Hopefully, the user follows the instructions so that the title is now a negotiable instrument that affectively transfers ownership in the vehicle to the new owner.

### Flow #2

The application program running on the smartphone may include only the Flow 1 part of the application or may also include a second component referred to as Flow #2. The Flow #2 component may instead be provided as a stand-alone component. After the user has signed the title and provided other information for affecting an ownership change, the Flow #2 component of the present method and apparatus operates. As seen in FIG. 23 of Flow 2, the smartphone display asks the user, at 218, to confirm that the title document and any other paperwork have been completed correctly. The user is requested, at 220, to use the camera device in the smartphone to photograph the front and back of the title document 222 and to forward the photographs to a reviewer to examination. The instructions also provide that the user is to photograph and send any power of attorney documents 224 or other documents as well. In a preferred embodiment, the instructions in Flow 2 are drawn from the instructions sent to the user at the end of Flow 1 and so include all the documents that the user was requested to provide at the end of Flow 1.

The display screen 226 includes a back button 228 to take the application back to the last screen of Flow 1, which here is the lienholders screen. The display has a help button 230 that is activated to provide assistance to the user. If the user has completed the screen of FIG. 23, the user selects the proceed command 232.

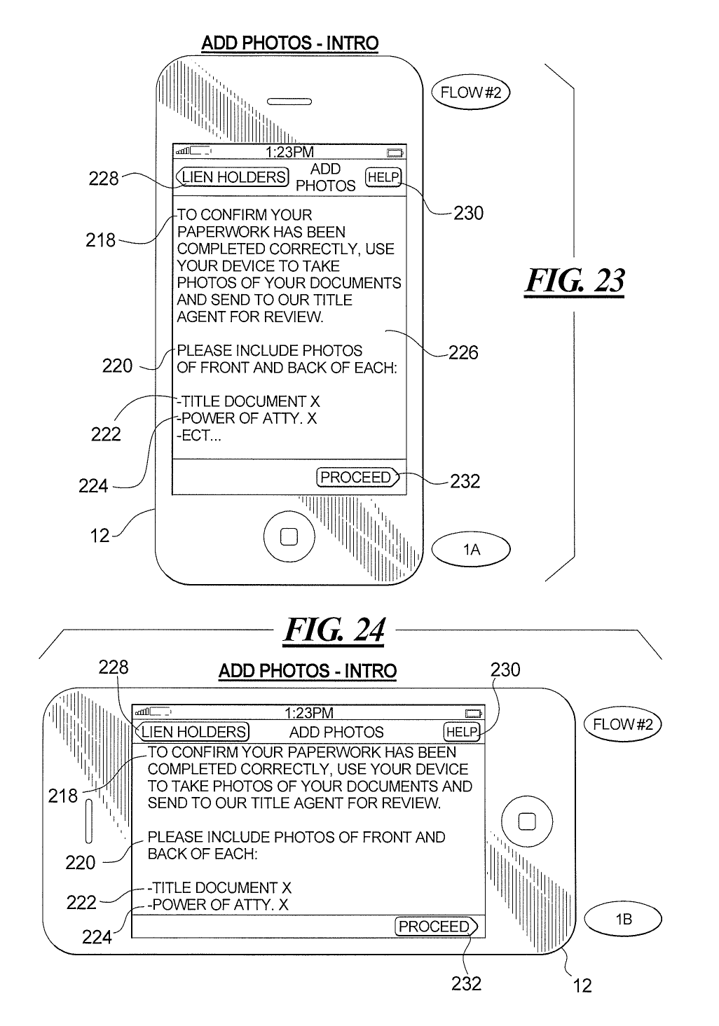

FIG. 24 of Flow 2 provides the same information as FIG. 23 but in a landscape format.

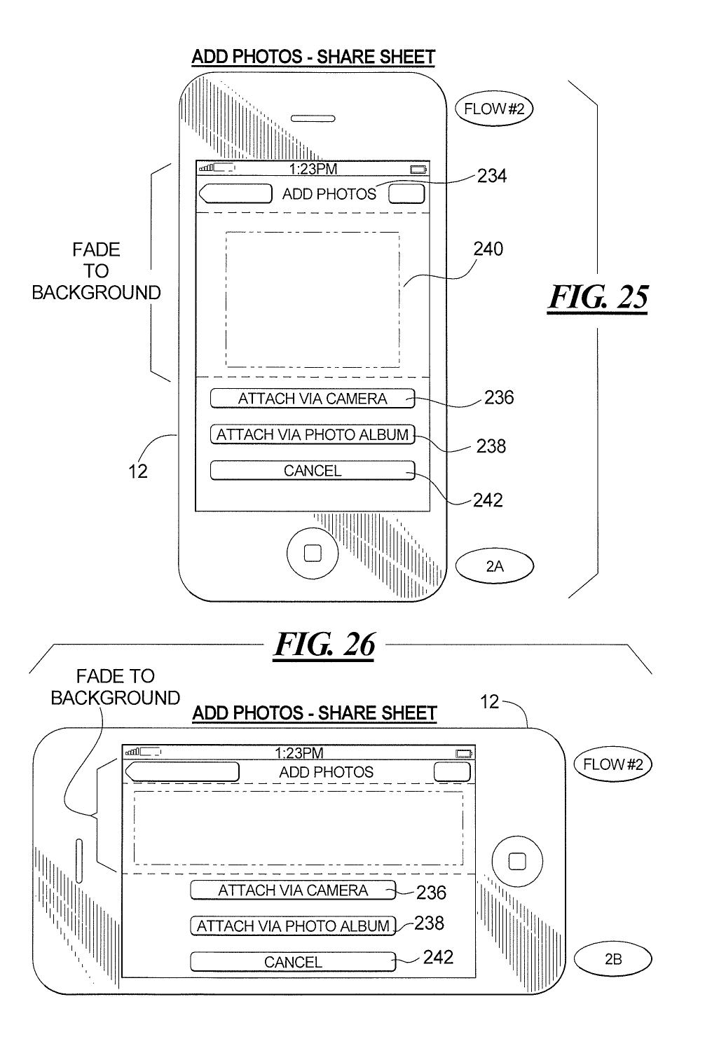

FIG. 25 of Flow 2 provides the tools for the user to provide the photographs of the documents. In the add photos section 234, an “attach via camera” button 236 is provided by which the camera of the smartphone is activated so that the user may take the requested photos. If the images were previously taken and stored within the smartphone device, the user selects the “attach via photo album” command 238 (or attach from another location where the images might be stored). The application program then permits the user to select existing photos. As the photos are attached, the photos may be listed on the display screen at 240. The user may cancel the photo attachment process, as desired, by selecting the cancel function 242.

FIG. 26 of Flow 2 provides the user with the choice of taking photos 236 or attaching existing photos 238 in the landscape orientation.

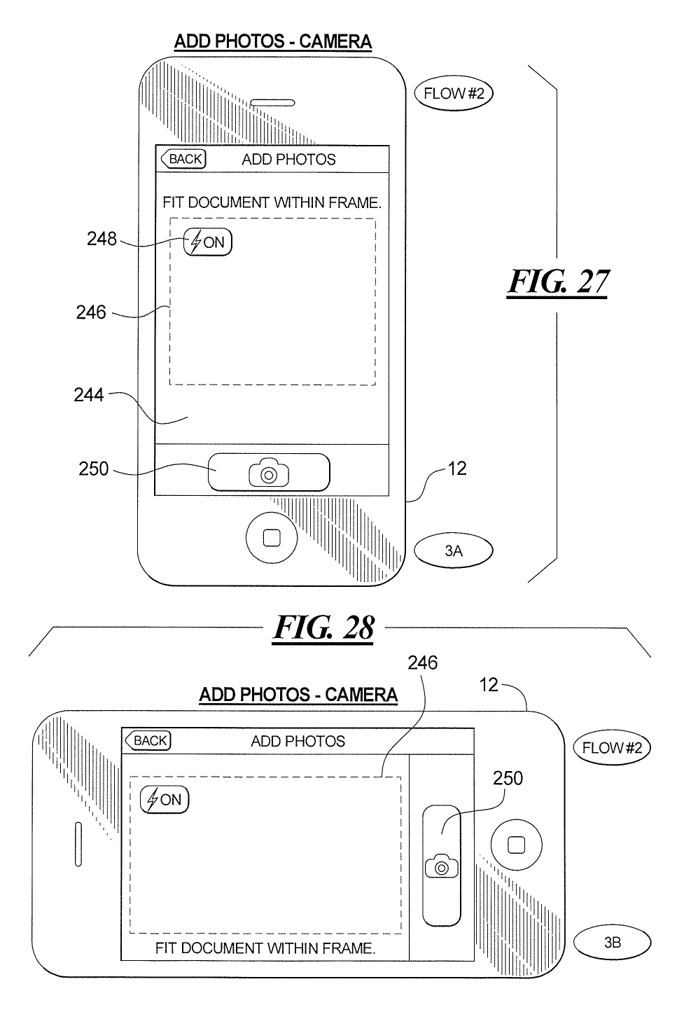

FIG. 27 of Flow 2 is reached by user selection of the “attach via camera” function 236 of the prior screen. The camera component is activated and the display 244 is provided with an outline 246 within which to position an image of the title document as seen by the camera. An indicator 248 showing whether the flash function of the camera is on or off is provided. The user is to orient the camera and document relative to one another so that the document appears within the outline 246 and then is to activate the shutter function 250 of the camera. This enables the camera to take a picture of the whole document so as to avoid having portions of the document cut off by the edges of the picture. The framing of the document picture also enables the document to have a consistent orientation for review.

FIG. 28 of Flow 2 shows the landscape orientation of the photo taking screen. The frame 246 is reoriented but the shutter button 250 remains located at the same location of the screen as the portrait mode display.

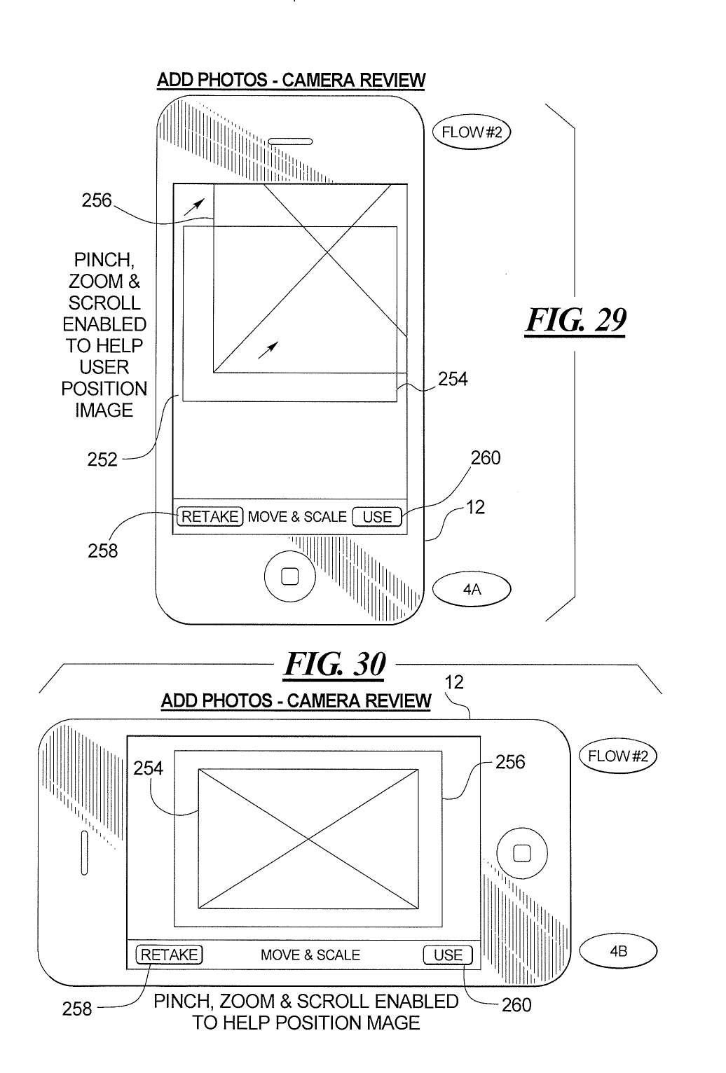

FIG. 29 of Flow 2 shows the move and scale screen 252 which enables the user to reposition the image 254 taken by the camera or retrieved from a stored photo 254 into a frame 256 shown on the display. The repositioning steps can be by scrolling using a finger swipe and zooming in or out using a pinch motion, for example. If the image is unsatisfactory, the user can retake the photo using the retake button 258. If the photo is acceptable, the user may select the “use” button 260.

FIG. 30 of Flow 2 provides the same functionality in a landscape orientation. In this illustration, the photo 254 is being resized to fit the frame 256.

After all the desired images are obtained, or after each image, the application uploads the image files to a server or other remote storage device via the communication link. FIG. 31 of Flow 2 shows a progress bar 262 as the photos are being uploaded. In a preferred embodiment, the background image 264 fades and darkens, and the image of the upload progress bar 262 is superimposed on it.

With reference to FIG. 1, the image file is uploaded to a server 20 or other storage device that can be accessed by a reviewer 22. For example the reviewer 22 has a computer 24 connected to the network 18 to access the images from a storage server 20. The reviewer 22 can examine the images of the title to determine whether the necessary information to affecting a title transfer has been provided on the title by the owner or user 10. Although the reviewer of one embodiment is a person, it is envisioned that an automate review of the documents may be provided according to the present invention.

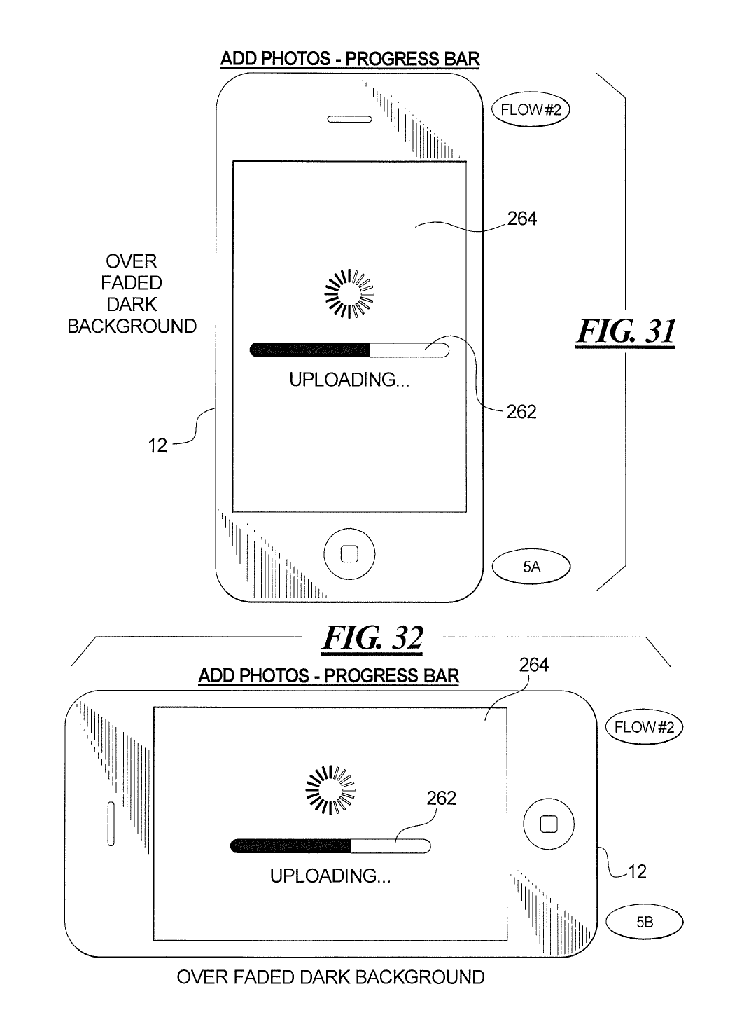

In FIG. 32 of Flow 2, the progress bar 262 for photo uploading is shown in landscape mode.

FIG. 33 of Flow 2 displays a confirmation 266 that the photo has been successfully uploaded. The application program may receive a confirmation message from the server in order to verify the successful upload. The screen displays an option 268 to the user to permit another photo to be uploaded if desired or to indicate that the uploading of photos is complete by selecting the “done” button 270.

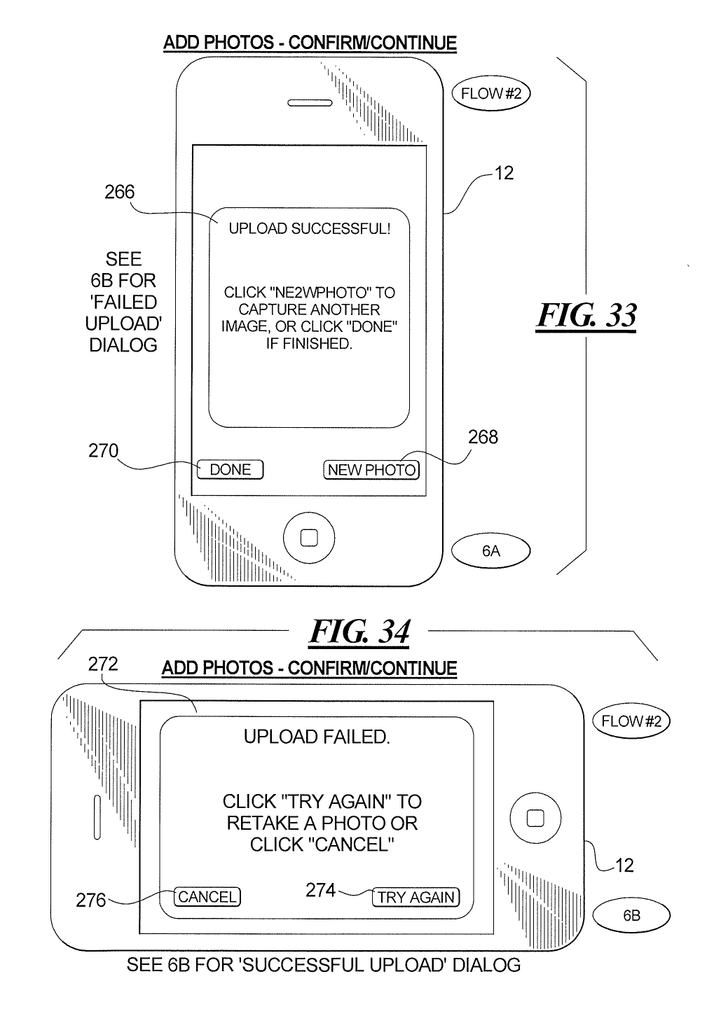

FIG. 34 of Flow 2 provides the landscape orientation of the photo confirmation screen, except that in this view the uploading of the photo has failed. The application program has not received a confirmation from the server of a successful upload. The user is informed at 272 of a failed upload and asked 274 if they which to try the upload again. If not, the user may select cancel 276.

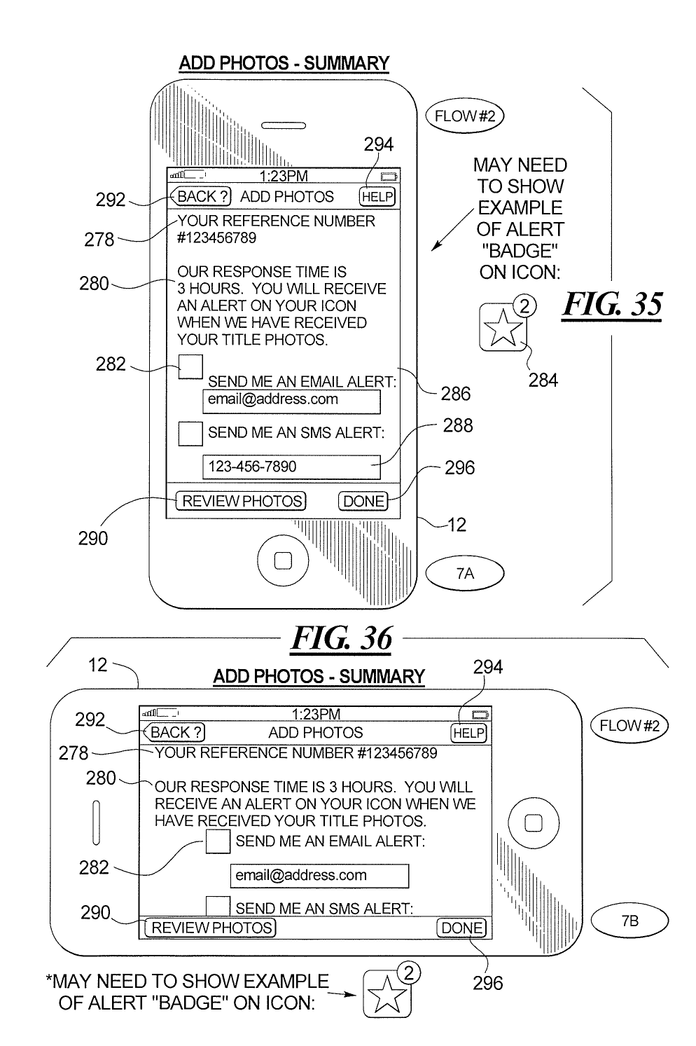

In FIG. 35 of Flow 2, the application program displays a reference number 278 for the uploaded photos. Should the user have questions about the review of the documents, the user may supply the reference number. Below the reference number 278 is an indication 280 of the response time for review of the documents. Here the response time is indicated as three hours in this example. The user is informed that an alert 282 will be received on the application icon when the title photos have been reviewed. The alert may appear as an addition to the icon 284, such as a red number within a circle at the upper corner of the icon for the app. Other alert means may be provided instead.

The user can also select other means for being notified that the review has taken place. For example, the user may select the command “send me an email alert” 286 and provide an email address to which to send the alert. The user may also, or instead, select “send me an SMS alert” 288 to receive a text message indicating that the document review has been completed. The user inputs a telephone number to which to send the text message, or SMS alert. The user may select the button 290 to review the photos that the user has uploaded, so that the user can see if all the documents to be reviewed have been uploaded correctly. The user can select the back button 292 to return to the photo uploading screens, for example, to upload further photos. A help button 294 is provided as on other screens. If the user is finished uploading photos of the title and related documents, the user may select the done button 296.

FIG. 36 of Flow 2 provides the same functionality as the add photos summary of FIG. 35 in a landscape display mode.

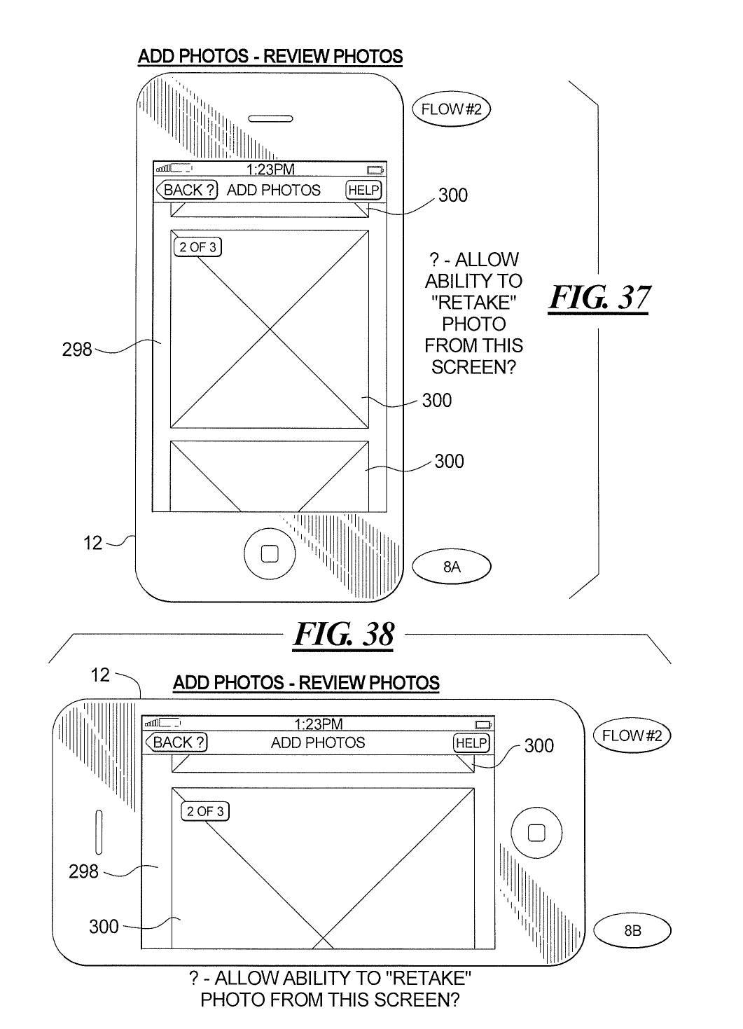

FIG. 37 of Flow 2 shows the display 298 after the user selects the review photos button 290. The photos 300 that were uploaded are presented in a scrollable display to permit the user to examine each photo to ensure that the portions of the document for review are readily visible in the image. Should the user determine that one or more uploaded photos 300 are not clear, the user can retake the photo from the review screen. For example, selection of a photo may open a function to retake the selected photo. The ability to retake the photos is an option in some embodiments of the present application but may be absent in others.

FIG. 38 of Flow 2 shows a landscape orientation of the same functionality as FIG. 37.

Returning to FIG. 1, the user 10 has uploaded the title copies and other related documents for review using the smartphone 12. The reviewer 22 has a computer 24 on which they access the uploaded copies of the title document and any related documents uploaded by the user. The reviewer 22 checks for issues such as signatures on the correct portion of the title, the correct number of signatures, mileage and other information that may be required to be filled in, a death certificate or other documents for an owner who has died, an executed power of attorney form where needed, and other such issues. The reviewer 22 is preferably an expert in title review. The reviewer 22 may contact the user 10 by telephone using the reviewer's telephone 26 to contact the user 10 over a telephone link 28, or the reviewer 22 may contact the user 10 via text message by sending SMS data to the phone number provided by the user 10. The communication may be over wired or wireless communication channels, or both. The telephone or text contact from the reviewer 22 may be a communication to let the user know that an additional document is required or that an additional signature is needed or some other action should be taken to correct an error or insufficiency in the title documents. The user 10 may then take action to correct the error or insufficiency. If the title was signed with a wrong name, such as a nickname or signed by someone who is not the owner, or if other issues exist that are not easily corrected by the user, the communication may be instructions from the reviewer to provide a power of attorney or other form so that the receiving entity can correct the problem or can have a new title issued. In a high percentage of cases, however, the customized instructions to the user relating to the version of the title that the user has on hand has resulted in the title being executed properly so as to be negotiable. In this case, the reviewer confirms that the documents are correct and complete and instructs the user to forward the title and related documents to the receiving entity.

As shown in FIG. 1, the reviewer 22 is to review documents from a plurality of users including a second user 30. The second user 30 uses the app to compare the title document on hand with samples shown on the smartphone 32, select the version of title on hand, receive instructions on affecting transfer of the title, and upload photos of the title and other documents for review.

Review of the documents by a reviewer is optional and uploading and review of the documents will not be performed in some embodiments of the present method and apparatus.

### Flow #3

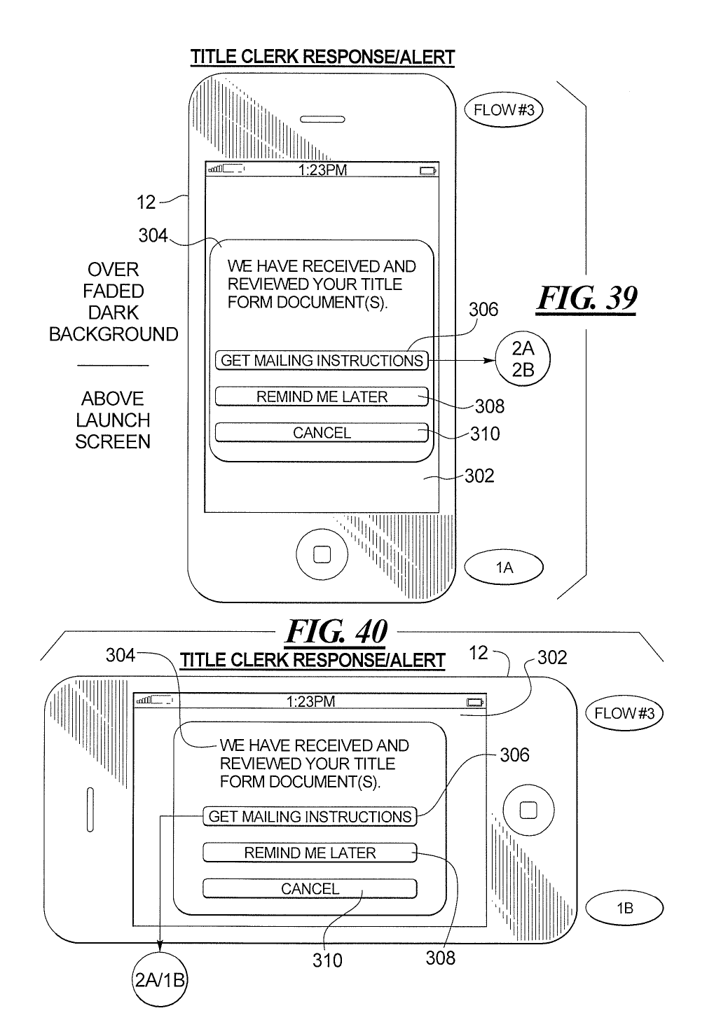

FIG. 39 of Flow #3 shows the screen 302 of the mobile device 12 after review by the reviewer 22 and transmittal of an alert to the mobile device 12. The user 10 sees the alert indicator on the smartphone 12 or other device and selects the alert or the app. The display informs the user at 304 that the title and other documents have been received and reviewed. The user 10 is provided the options 306 of getting the mailing instructions for sending the title documents to the recipient, such as the insurance company or a third party, by selecting the corresponding button, or to request 308 that the application remind the user later regarding the forwarding of the title documents. The user in this embodiment also has the choice of cancelling 310.

FIG. 40 of Flow 3 also has this functionality but in a landscape display mode. The screens of FIGS. 39 and 40 of Flow 3 may be displayed if the reviewer finds the title and other documents to be acceptable so that they should be mailed to the recipient. The reviewer may instead recognize that the documents can be corrected by the recipient, such as under authority of the power of attorney, and so may indicate that the documents are to be mailed.

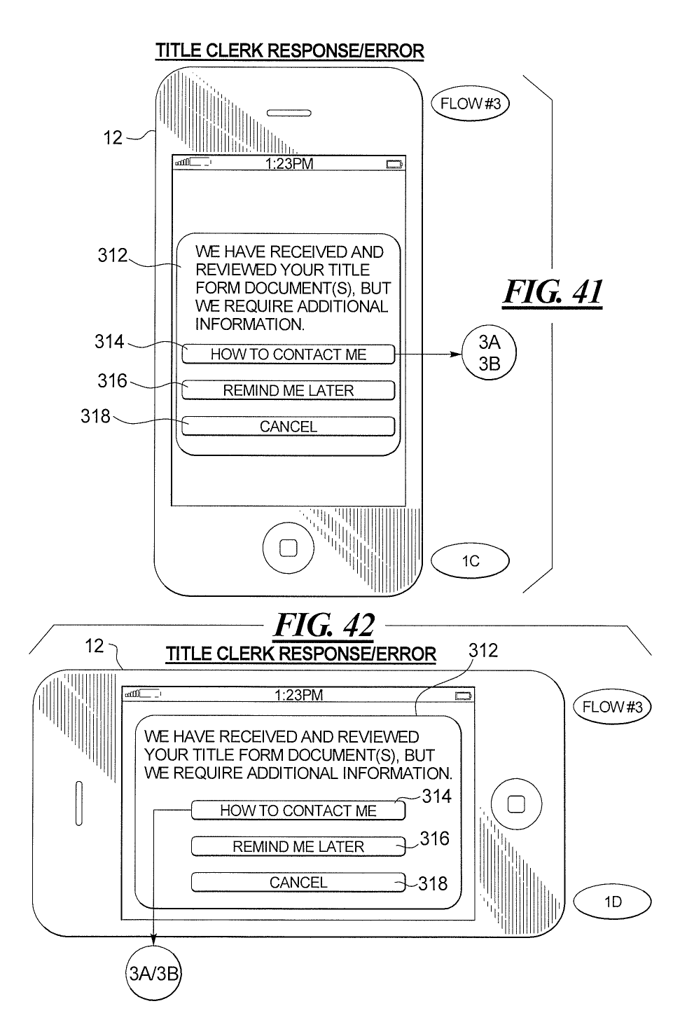

In FIG. 41 of Flow 3, the reviewer has found a problem with the documents and has sent a command to the application to display a screen 312 informing the user that additional information is required. The display includes a “how to contact me” button 314 by which the user is able to inform the reviewer how the user may be contacted so that the additional information can be included. The application also includes a “remind me later” button 316 so that the user may send the contact information at a later time. The user may cancel 318 the information request.

FIG. 42 of Flow 3 shows the same functionality as FIG. 41 in a landscape orientation.

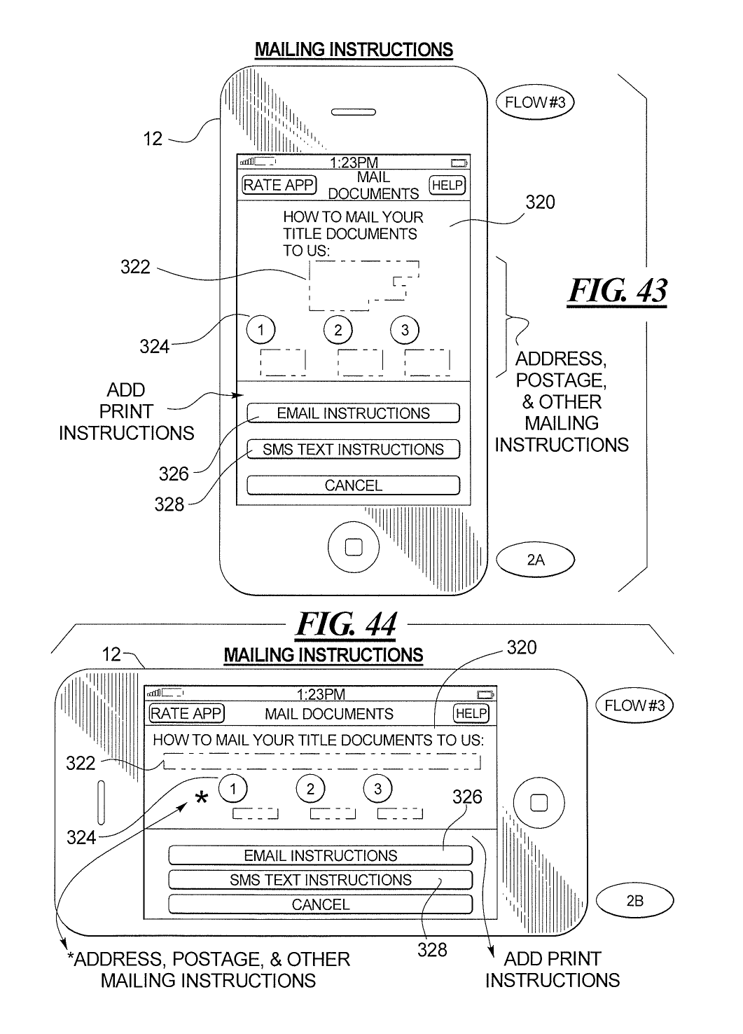

FIG. 43 of Flow 3 is reached by the user selecting the get mailing instructions button on the screen shown in FIG. 39 or 40 of Flow 3. The mail documents screen 320 includes instructions on how to mail the documents to the recipient. The mailing address 322 and mailing instructions 324 are provided. In the illustrated embodiment, the mailing instructions 324 include three numbered steps. The mailing instructions 324 preferably indicate to send the documents via a verifiable means, such as certified mail. The postage for mailing the documents may also be provided. The user may select a command to print the mailing instructions and address. The user may also select commands to email 326 the instructions or to SMS text 328 the instructions.

FIG. 44 of Flow 3 presents the mailing instructions in a landscape format.

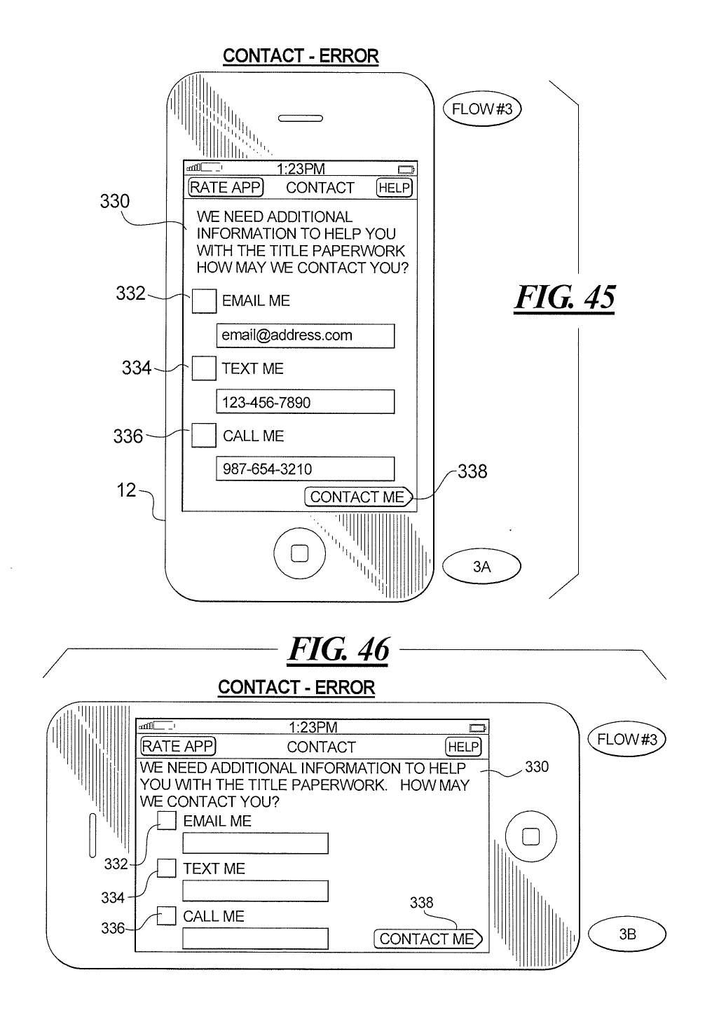

In FIG. 45 of Flow 3, the reviewer 22 has a need to contact the user 10 regarding the title documents. The screen 330 informs the user that additional information is needed to help complete the title paperwork. The screen 330 requests that the user 10 provide contact information, including for example an email address 332, a number for texting 334, or a telephone number 336 for a telephone call. The user 10 enters any or all of the contact means and selects the button “contact me” 338. The contact to the user is via the telephone 26 or computer 24 as shown in FIG. 1.

FIG. 46 of Flow 3 provides the contact screen in landscape format.

The reviewer 22 of FIG. 1 may be one of many reviewers at a call center, or the reviewers may be distributed in various offices or work-from-home locations. The network 18 and servers 14 and 20 may be at a central location or distributed, as desired.

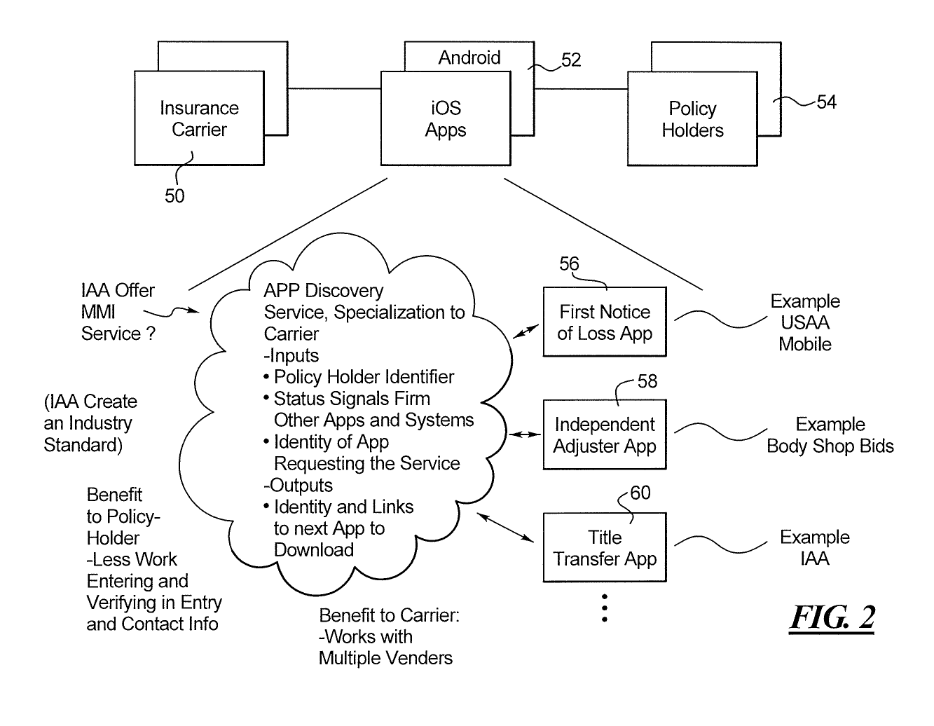

FIG. 2 is a block diagram showing insurance carriers 50 that insure the vehicles of users. The insurance carriers 50 interact with the electronic devices 52, such as iOS devices and Android devices, of policy holders 54 to perform the present method. The electronic devices 52 may operate various applications or apps that are useful in the interaction between the parties. The electronic device 52 may operate a first notice of loss app 56, for example according to USAA mobile. The electronic device may operate an independent advisor app 58, such as to examine BodyShopBids.com. After a determination has been made for the insurance carrier 50 to take ownership of the insured vehicle as part of a settlement of a damage claim, the user or policy holder 54 is asked to install and execute the title transfer app 60, as set forth in the foregoing figures showing exemplary screens. As such, the policy holder 54 can manage many aspects of the vehicle insurance and claim process via applications on the user's smartphone.

The apps 56, 58 and 60 communicate with an app discovery service that may be specialized to the insurance carrier. The app discovery service asks for inputs from the user such as a policy holder identifier, status signals from other apps and systems, and an identification of the app requesting the title service. The outputs of the discovery service may include the identity of and links to the next app to download.

According to one aspect of the invention, a company may offer the application, or app, discovery service. The app discovery service could be company specific or encompass several companies within the vehicle transfer business. The method provides a benefit to the policy holder by providing specific instructions for the version of title at hand. Less work is required by the user in entering and verifying one's identity and contact information. The method provides a benefit to the carrier or company because the method works with multiple apps associated with the vehicle insurance and claims process.

In a preferred embodiment, the app discovery service is offered to the policy holder of an insurance company and is customized to the policy holder based on the loss situation that the policy holder has experienced, as well as being customized to the particular insurance carrier and to the particular policy holder. The app discovery service guides the user in locating apps, or application programs, that assist the user in dealing with the insurance claim and related steps resulting from an accident, for example. In one example, a first policy holder has had an automobile accident at a first geographic location. The user is directed by the app discovery service to download an app to the user's smartphone that is used to communicate a first notice of loss to the insurance carrier, for example the USAA Mobile App for the USAA insurance carrier. The insurance carrier app directs the user to download an app for obtaining an estimate of the cost of repairing the damage using the app discovery service. In one example, the user is directed to download the BodyShopBids.com app. Repair estimates are obtained using the repair estimates app. If the repair estimate is high enough that the vehicle is classed as a total loss (totaled) then the app discover service may be used by the BodyShopBids.com app to direct the user to download the title transfer app of IAA as described herein, by which the title of the vehicle is transferred to a vehicle auction service.

For a second policy holder who experiences an accident while insured by a different insurance company, the policy holder is instructed to download a notice app for the other insurance company. If the policy holder is insured by the same insurance carrier as the first policy holder, the second policy holder will be requested to download the first notice of loss app, just as the first policy holder has. If the accident was in a different geographic area for which the first bid service is not a vendor of the insurance carrier, then an app for a second bid service may be provided. If the accident was in an area for which the first auction service is not a vendor of the insurance carrier, then the app discovery service will determine the appropriate app for a vehicle auction service in that geographic area. The app discovery service uses information input by the user to guide the user to the correct application programs to successfully transit the claim process. Thus, the apps recommended for downloading from the app discovery service will depend on the policy holder, the insurance carrier, the accident location and possibly other factors.

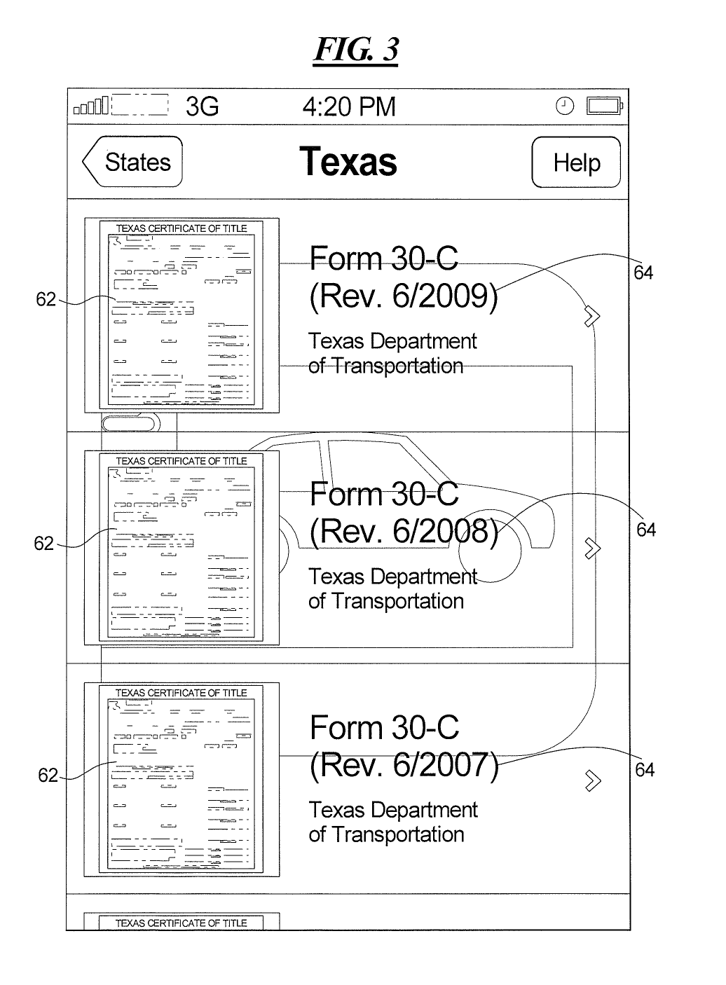

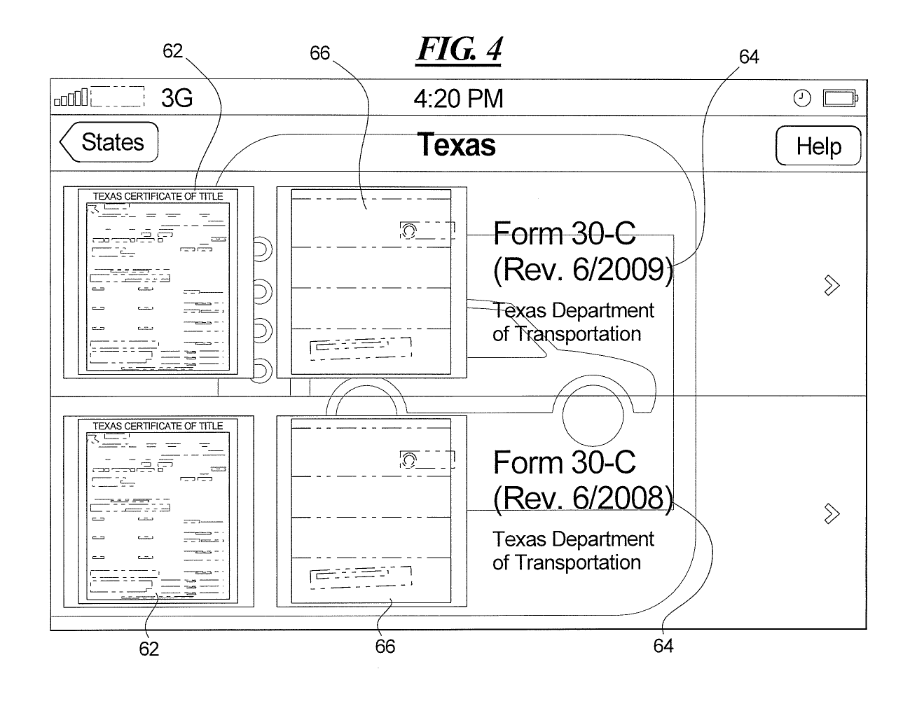

Screen shots of the title versions thumbnail screens of FIG. 13 of Flow 1 are shown in FIGS. 4 and 5. In the portrait orientation of FIG. 4, only the front 62 of the sample title forms is shown, along with the revision date 64 and issuing agency for each form version. FIG. 5 shows the thumbnail samples in both front 62 and back views 66 in the landscape orientation mode.

Thus, there has been shown and described a method and system for reviewing vehicle title documents in preparation for a title transfer, in determining a version of the title at hand, in receiving instructions for execution of the title, in reviewing the executed title, and in forwarding the title documents to a recipient. Mistakes in executing the title documents so as to be negotiable are reduced.

With the present method and apparatus, the instances of incorrect titles being sent to an insurance carrier or vehicle auction company are reduced. Problems are caught and possibly corrected before the title document leaves the hands of the user or policy holder. By reducing the number of erroneous titles received, the transfer of the title is quicker, at lower cost to the entities involved.

Although other modifications and changes may be suggested by those skilled in the art, it is the intention of the inventors to embody within the patent warranted hereon all changes and modifications as reasonably and properly come within the scope of their contribution to the art.

I claim:

1. A method for transferring a title of a vehicle title at hand, comprising:
in an electronic device, identifying a state that issued the title at hand;
in an electronic device, identifying a version of the title at hand;
in an electronic device, identifying a number of owners on the title at hand;
in an electronic device, identifying any lienholders of the title at hand;
in an electronic device, receiving instructions for executing the title as a negotiable title.

2. A method as claimed in claim 1, wherein said electronic device is a smartphone.

3. A method as claimed in claim 1, further comprising:
in an electronic device, photographing executed title documents of the title at hand;
in an electronic device, uploading the photographs of the title documents to a storage device for review by a reviewer; and
in an electronic device, receiving a report from the reviewer regarding the reviewed title documents.

4. A method as claimed in claim 1, further comprising:
in an electronic device, corresponding with the reviewer regarding the reviewed title documents.

5. A method as claimed in claim 1, further comprising:
in an electronic device, receiving mailing instructions relating to the executed title at hand.

6. A method as claimed in claim 1, further comprising:
displaying a plurality of versions of title documents on a display of the electronic device;
changing between versions of the title documents by scrolling in a first direction;
displaying a plurality of views of each version of the title documents, said views including at least a front view and a back view of the title documents; and
changing between views of a title document by scrolling in a second direction.

7. A method as claimed in claim 6, wherein said changing between versions is by
swiping on a touch sensitive display in a first direction; and
said changing between views is by swiping on the touch sensitive display in a second direction substantially perpendicular to the first direction.
